(19) United States
(12) Patent Application Publication
(10) Pub. No.: US 2015/0107952 A1
(43) Pub. Date: Apr. 23, 2015

(54) METHOD OF MODIFYING A LOCK UP TORQUE CONVERTER ASSEMBLY FOR HIGH PERFORMANCE APPLICATIONS

(71) Applicant: Kenneth KELLY, Aston, PA (US)

(72) Inventor: Kenneth KELLY, Aston, PA (US)

(21) Appl. No.: 14/520,614

(22) Filed: Oct. 22, 2014

Related U.S. Application Data
(60) Provisional application No. 61/894,724, filed on Oct. 23, 2013.

(51) Int. Cl. F16H 45/02; F16H 41/28; F16H 41/04

(52) U.S. Cl. CPC F16H 45/02; F16H 41/04; F16H 41/28
USPC 192/3.28; 29/889.1

(57) ABSTRACT

An assembly kit and of method for modifying a standard torque converter assembly is provided. The assembly kit and method of modification results in a modified torque converter assembly that can withstand high horse power engine/transmission requirements with minimal additional/replacement parts and manufacturing steps.

### CROSS-REFERENCE TO RELATED APPLICATION

This application claims the benefit of priority of U.S. provisional application No. 61894724, filed 23 Oct. 2013, the contents of which are herein incorporated by reference.

### BACKGROUND OF THE INVENTION

The present invention relates to torque converters and, more particularly, to a method of making a high performance lock up torque converter assembly.

Standard torque converters, such as Original Equipment (OE) torque converters will fail under high horsepower and torque applications, including the high performance engine/transmission applications of race cars. Specifically, the OE torque converter will flex under the stress of higher RPMs created by the high performance application, wherein its clutch lining will wear resulting in transmission failure. An OE lock up converter is limited to approximately 1600-1800 RPMs stall where a high performance lock up engine and transmission require a minimum of approximately 2800 RPMs stall. As a result, this limits the amount of horsepower and torque a race car can withstand before torque converter failure.

However, the OE lock up torque converter can be modified to withstand an approximate 370% increase in horsepower and torque capacity by the removal of original components and the replacement and addition of certain aftermarket components. The resulting smaller, stronger converter will produce the required stall speeds that high horse power engines and transmissions require to function properly.

As can be seen, there is a need for an assembly kit and method of modifying standard torque converters to withstand high horse power engine/transmission requirements.

### SUMMARY OF THE INVENTION

In one aspect of the present invention, a method for modifying a standard torque converter assembly comprising an original hub, an original cover, a plurality of snap rings, an original sprag center, an original turbine hub and an original clutch plate so as to withstand high performance torque applications, comprises: providing an assembly kit comprising: a new lock up cover, at least one new lock up plate, a new turbine hub, a new sprag center and a new impeller hub; removing the original cover and the original hub of the standard torque converter assembly; rigidly coupling the new impeller hub to replace the original hub; removing the plurality of snap rings so as to replace the original sprag center with the new sprag center; machine off the original turbine hub so as to replace the original turbine hub with the new turbine hub; set and machine the new lock up plates to operably engage the new turbine hub; adding at least one clutch plate to operably engage the new lock up plate; and rigidly connect the new lock up cover to form the modified torque converter assembly.

In another aspect of the present invention, an assembly kit for modifying a standard torque converter assembly so as to withstand high performance torque applications, comprising: a lock up cover, wherein the new lock up cover is forged from a unitary piece of high grade steel, whereby the new lock up cover is smaller and stronger relative to the original cover.; at least one lock up plate; a turbine hub; a sprag center; an impeller hub; and at least one clutch plates.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, illustrating use;

FIG. 2 is a section view of an exemplary embodiment of the present invention, taken along line 2-2 in FIG. 1;

FIG. 3 is an exploded view of an exemplary embodiment of the present invention; and

FIG. 4 is a reverse exploded view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an assembly kit and of method for modifying a standard torque converter assembly so that the resulting modified torque converter assembly can withstand high horse power engine/transmission requirements with minimal additional/replacement parts and manufacturing steps.

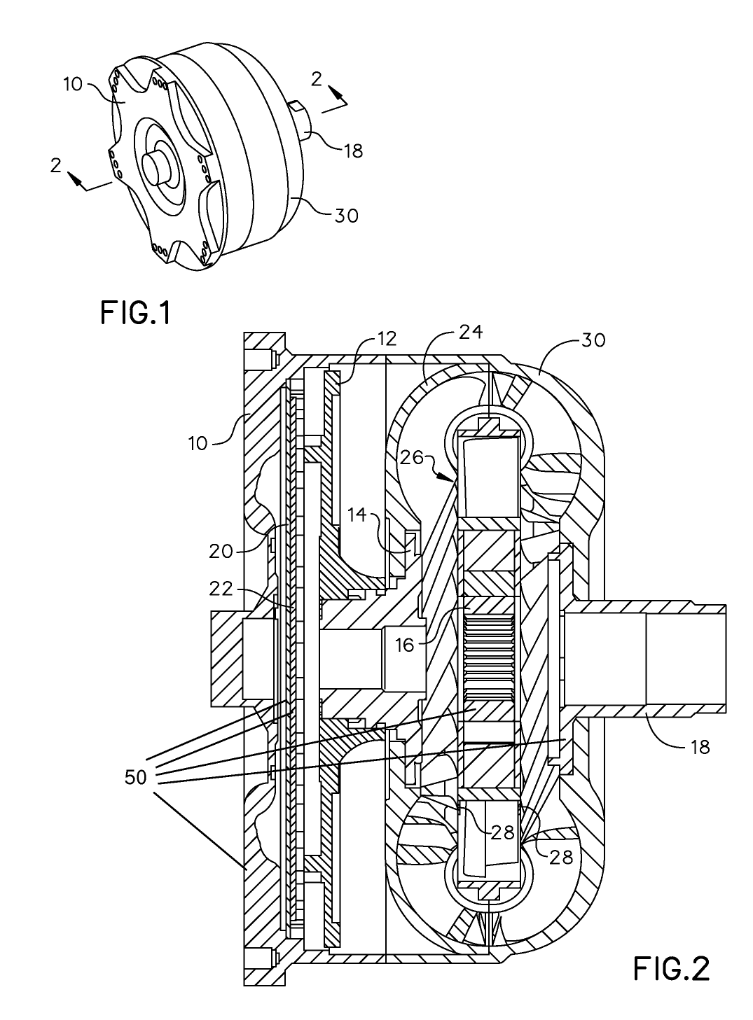

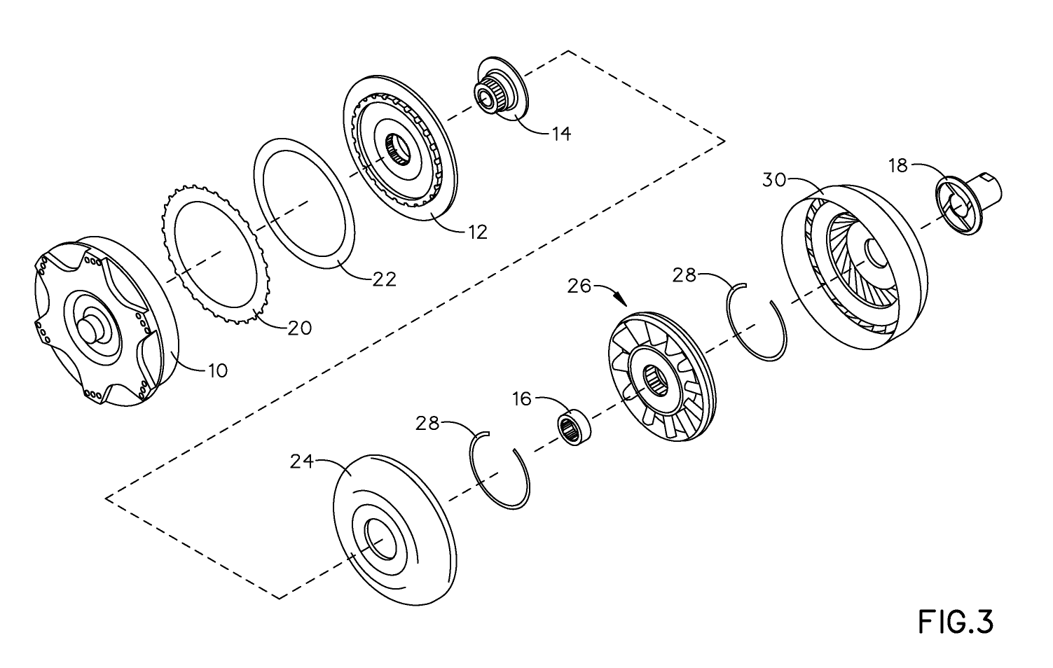

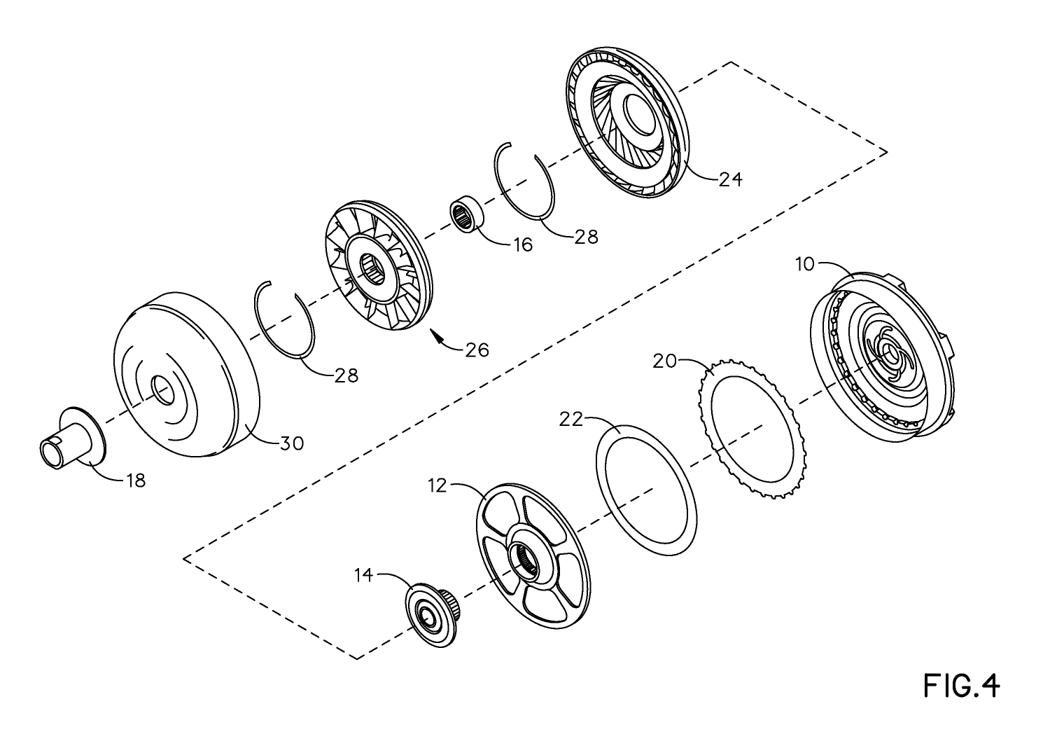

FIGS. 1 through 4 illustrate the additional components of an assembly kit 50 and of a method for modifying a standard torque converter assembly embodied in the present invention. The resulting modified torque converter assembly can withstand high horse power engine/transmission requirements with minimal additional/replacement parts and manufacturing steps, as both may share an original turbine 24, an original stator assembly 26, a plurality of snap rings 28 and an original impeller 30.

The assembly kit 50 may include a lock up cover 10, at least one lock up plate 12, a turbine hub 14, a sprag center 16 an impeller hub 18 and a plurality of clutch plates 20, 22. The lock up cover 10 may be forged from a unitary piece of high grade steel to prevent flexing and be smaller and stronger than the original torque converter cover, which is typically stamp formed, it is geared to replace.

The at least one lock up plate 12 may be a solid, unitary construction. The at least one lock up plate 12 may provide extra wide lining. Each plate 12 may be larger and thicker so as to enable the use of the plurality of lock up clutch plates 20, 22 engaged between the cover 10 and the plate 12. The method of modification provides increased clutch surface/capacity than the original assembly because the modified assembly houses the plurality of lock up clutch plates 20, 22 as compared to the original assembly's single clutch plate.

The turbine hub 14, the sprag center 16 and the impeller hub 18 will be aftermarket components of higher quality, hardened steel relative to the parts they are replacing so that they can withstand higher horsepower/torque applications.

In assembly kit 50 as a whole, facilitates a stronger, smaller diameter modified torque converter assembly so as to enable higher stall speeds under high performance applications with no internal clutch failure.

The method for modifying the standard torque converter assembly embodied in the present invention may include the following. The assembly kit 50 disclosed above may be provided. The user may remove the original hub and rigidly couple the aftermarket flanged impeller hub 18 to the original impeller 30. The rigid coupling may be by welding. Then the user may remove the plurality of snap rings 28 so as to replace the original sprag center with the aftermarket sprag center 16. Then the user may machine off the original turbine hub and rigidly couple the aftermarket turbine hub 14. Then the user may set and machine proper clearances for the lock up plates 12 and plurality of lock up clutch plates 20, 22 so that the lock up cover 10 may be rigidly coupling to the original impeller 30, thereby forming the modified torque converter assembly. The modified torque converter assembly may have applications in high performance transmissions operably with, for example, General Motors 4L60E, 4L80E and the 6L80 torque converter.

It should be understood, of course, that the foregoing relates to exemplary embodiments of the invention and that modifications may be made without departing from the spirit and scope of the invention as set forth in the following claims.

What is claimed is:

1. A method for modifying a standard torque converter assembly comprising an original hub, an original cover, a plurality of snap rings, an original sprag center, an original turbine hub, an original impeller and an original clutch plate so as to withstand high performance torque applications, comprising:
providing an assembly kit comprising: a, at least one new lock up plate, a new turbine hub, a new sprag center and a new impeller hub;
removing the original cover and the original hub of the standard torque converter assembly;
rigidly coupling the new impeller hub to the original new lock up cover impeller so as to replace the original hub;
removing the plurality of snap rings so as to replace the original sprag center with the new sprag center;
machining off the original turbine hub so as to replace the original turbine hub with the new turbine hub;
setting and machining the new lock up plates to operably engage the new turbine hub;
adding at least one clutch plate to operably engage the new lock up plate; and
rigidly connect the new lock up cover to the original impeller, whereby forming a modified torque converter assembly.

2. The method of claim 1, wherein the new lock up cover is forged from a unitary piece of high grade steel, whereby the new lock up cover is smaller and stronger relative to the original cover.

3. The method of claim 1, wherein the at least one clutch plate comprises two lock up clutch plates, whereby providing an increase in clutch surface of the modified torque converter assembly relative to the standard torque converter assembly.

4. An assembly kit for modifying a standard torque converter assembly so as to withstand high performance torque applications, comprising:
a lock up cover;
at least one lock up plate;
a turbine hub;
a sprag center;
an impeller hub; and
at least one clutch plates.

5. The assembly kit for modifying a standard torque converter assembly of claim 4, wherein the new lock up cover is forged from a unitary piece of high grade steel, whereby the new lock up cover is smaller and stronger relative to the original cover.

6. The assembly kit for modifying a standard torque converter assembly of claim 4, wherein the at least one clutch plate comprises two lock up clutch plates.
